(19) United States
(12) Patent Application Publication
(10) Pub. No.: US 2006/0280202 A1
(43) Pub. Date: Dec. 14, 2006

(54) MEMS sensor with configuration module

(75) Inventor: Thomas W. Kelly, North Andover, MA (US)

Correspondence Address: Steven G. Saunders;Bromberg & Sunstein LLP, 125 Summer Street, Boston, MA, 02110-1618, US

(73) Assignee: Analog Devices, Inc.

(21) Appl. No.: 11/150,983

(22) Filed: Jun. 13, 2005

(51) Int. Cl. H04J 15/00

(52) U.S. Cl. 370/464

(57) ABSTRACT

A MEMS device has 1) a communication module for communicating with an external device, and 2) a configuration module operatively coupled with the communication module. The configuration module configures the communication protocol of the communication module. The communication module communicates with the external device as specified by the communication protocol.

### FIELD OF THE INVENTION

The invention generally relates to MEMS devices and, more particularly, the invention relates to configuring MEMS devices.

### BACKGROUND OF THE INVENTION

A variety of different applications use MEMS sensors to detect the motion of an underlying object. For example, MEMS sensors (e.g., accelerometers or gyroscopes) often are mounted about the periphery of the automobile chassis to sense pre-specified accelerations or rotations. The sensors typically cooperate with a central computer that both coordinates their function and responds to pre-specified types of detected motion.

Upon detection of a pre-specified type of motion, the sensors transmit motion data to the computer, which causes systems within the automobile to respond in an pre-specified manner. For example, if the sensors detect a sudden and high deceleration, air-bag systems may deploy their air bags. Alternatively, if the sensors detect a sudden rotation (e.g., the automobile is swerving), breaking systems may selectively break to avoid a rollover. Accordingly, sensors have become critical in ensuring automobile safety.

The MEMS sensors typically use highly developed communication protocols to communicate with the central computer. Accordingly, known prior art MEMS sensors are preconfigured to comply with one of a wide variety of different communication protocols. Such protocols, however, are proprietary to different sensor manufacturers and/or may not fulfill the requirements of a particular system.

In a corresponding manner, automobile systems (e.g., the central computer) also are configured to comply with one of those proprietary protocols. Once configured in a given manner, automobile systems therefore only can use sensors that implement the single proprietary protocol. Consequently, rather than focusing on sensor performance, purchasing decisions for such sensors often are driven by the need for backward compatibility of the communication protocol.

### SUMMARY OF THE INVENTION

In accordance with one aspect of the invention, a MEMS device has 1) a communication module for communicating with an external device, and 2) a configuration module operatively coupled with the communication module. The configuration module configures the communication protocol of the communication module. The communication module communicates with the external device as specified by the communication protocol.

The MEMS device also may have an input for receiving configuration data. The configuration module thus configures the communication module in accordance with the configuration data received through the input. In some embodiments, the MEMS device has memory operatively coupled with the configuration module. The configuration module thus has logic for storing configuration data in the memory. Among other things, the memory may include one-time programmable read-only memory.

In other embodiments, the configuration module includes control logic for controlling at least one of data width and error detection. Moreover, the configuration module may include a link layer module configured to control link layer communication of the communication module, and/or a physical layer module configured to control physical layer communication of the communication module. In fact, the configuration module also may include an application layer module configured to control application layer functions of the MEMS device.

The some embodiments have a movable mass for detecting an environmental quality. The communication module communicates data relating to the detected environmental quality to the external device.

In accordance with another aspect of the invention, a method of configuring a sensor system provides a MEMS device having 1) a communication module for communicating with an external device, and 2) a configuration module operatively coupled with the communication module. The method then determines at least one communication protocol parameter for controlling communication of the communication module with the external device. Next, the method forwards the at least one communication protocol parameter to the configuration module. The configuration module stores the at least one communication protocol parameter in memory for retrieval by the communication module.

In some embodiments, the method forwards a confirmation message having data identifying 1) the at least one communication protocol parameter and 2) a location in memory storing the at least one communication protocol parameter. The MEMS device also may have a sensor for sensing an environmental quality. The communication module thus is incapable of communicating data relating to the sensed environmental quality (to the external device) until after the at least one communication protocol parameter is stored in the memory. In other embodiments, the method detects that the MEMS device executed a startup process, and writes the at least one communication protocol parameter from the memory into a volatile memory after startup is detected.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

The foregoing and advantages of the invention will be appreciated more fully from the following further description thereof with reference to the accompanying drawings wherein:

FIG. 1 schematically shows an automobile inertial sensing system that may use an inertial sensor configured in accordance with illustrative embodiments of the invention.

FIG. 2 schematically shows an inertial sensor that may be configured in accordance with illustrative embodiments of the invention.

FIG. 3 schematically shows a block diagram of various functional modules within the sensor shown in FIG. 2.

FIG. 4 schematically shows a block diagram of various functional modules within the configuration module of FIG. 3.

FIG. 5 shows a process of configuring the sensor shown in FIGS. 2-3 in accordance with illustrative embodiments of the invention.

FIG. 6 shows a illustrative process of initializing the sensor at start up.

### DESCRIPTION OF ILLUSTRATIVE EMBODIMENTS

In illustrative embodiments of the invention, a generic MEMS sensor has a local configuration module that enables it to communicate with an external device executing any one of a wide variety of different communication protocols. Accordingly, an end-user, such as an automotive airbag system manufacturer, can customize the sensor to comply with its internal communication protocols. Such an end-user therefore is not limited to using sensors configured for only a single set of communication protocols. Details illustrative embodiments are discussed below.

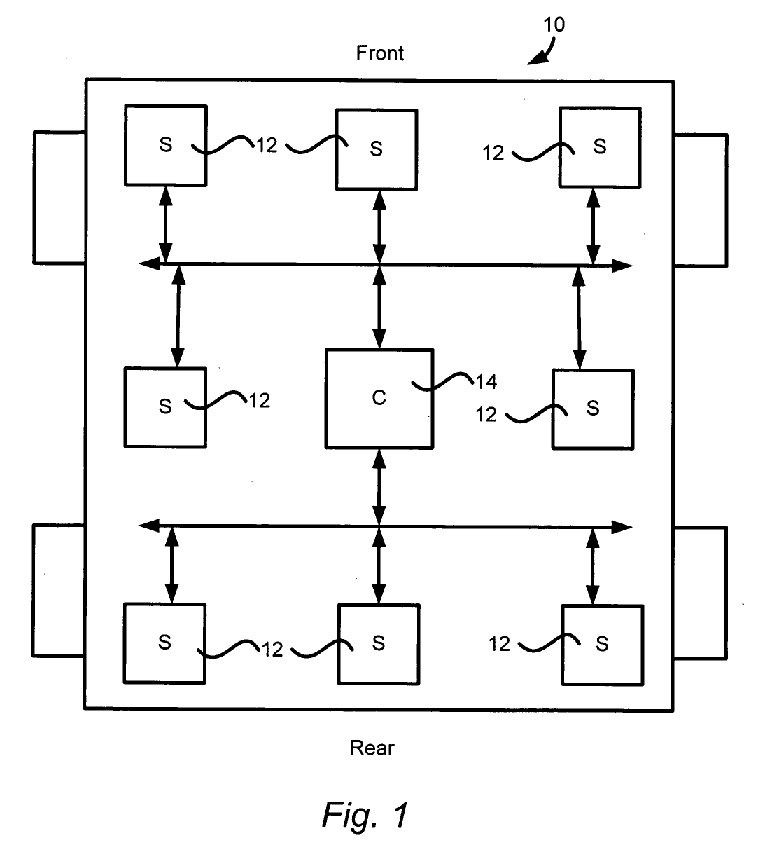

FIG. 1 schematically shows an arrangement that may use sensors implementing illustrative embodiments of the invention. More particularly, the sensing arrangement shown senses movement of an automobile 10. To that end, the sensor arrangement includes a plurality of inertial sensors 12 that communicate with a central computer 14 through some interconnection medium. The sensors 12 may include, among other things, accelerometers for detecting automobile acceleration, and gyroscopes for detecting rotational movement of the automobile 10.

Exemplary MEMS accelerometers are discussed in greater detail in U.S. Pat. No. 5,939,633, which is assigned to Analog Devices, Inc. of Norwood, Mass. Exemplary MEMS gyroscopes are discussed in greater detail in U.S. Pat. No. 6,505,511, which also is assigned to Analog Devices, Inc. of Norwood, Mass. The disclosures of U.S. Pat. Nos. 5,939,633 and 6,505,511 are incorporated herein, in their entireties, by reference.

Although the MEMS sensors 12 are discussed above as inertial sensors, principles of illustrative embodiments can apply to other MEMS devices, such as pressure sensors and microphones. Accordingly, discussion of an inertial sensor is exemplary and not intended to limit the scope of various embodiments of the invention. In a similar manner, it also should be noted that discussion of sensors within an automobile context is for illustrative purposes only. Accordingly, discussion of sensors within this context is not intended to limit the scope of various embodiments of the invention.

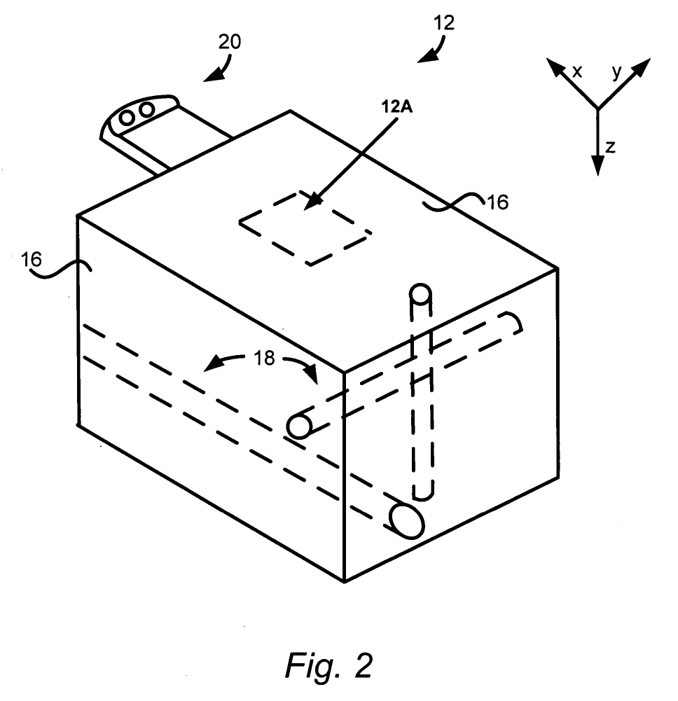

FIG. 2 schematically shows a simplified view of a sensor 12 (referred to as a “satellite sensor 12”) configured in accordance with illustrative embodiments of the invention. Note that FIG. 2 is not necessarily drawn to scale. The satellite sensor 12 has a body 16 containing an inertial sensor device 12A (e.g., a MEMS gyroscope or accelerometer, shown in phantom) and a mounting system 18 for mounting the sensor 12 to a mounting apparatus in an underlying structure (e.g., an automobile chassis). The satellite sensor 12 also has an interface port 20 for communicating with external electronic devices (e.g., the central computer 14 system shown in FIG. 1). The interface port 20 has the mechanical coupling structure for coupling with a wiring harness, and one or more leads (not shown) to electrically communicate with an external electronic device.

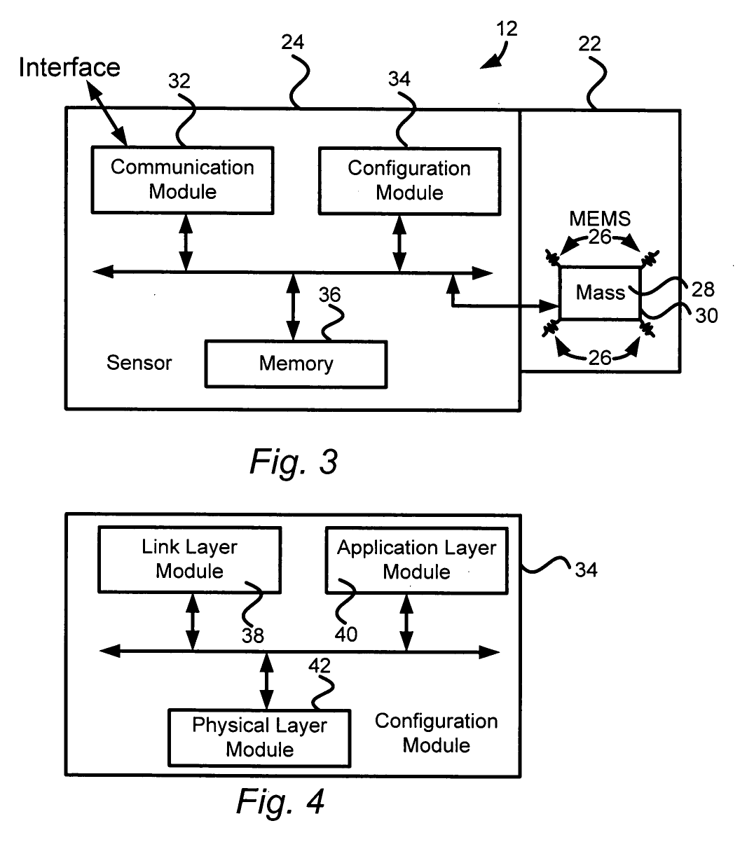

FIG. 3 schematically shows a block diagram of a satellite sensor 12 configured in accordance with illustrative embodiments of the invention. Specifically, the satellite sensor 12 is formed on a single die considered to have a sensor portion 22 and a circuitry portion 24. The sensor portion 22 has a plurality of springs 26 suspending a movable structure 28 (e.g., a mass) from a substrate 30. As known by those skilled in the art, the movable structure 28 moves in a predetermined manner when subjected to an acceleration or rotation. Additional illustrative details of the sensor portion 22 are discussed in the above referenced United States patents.

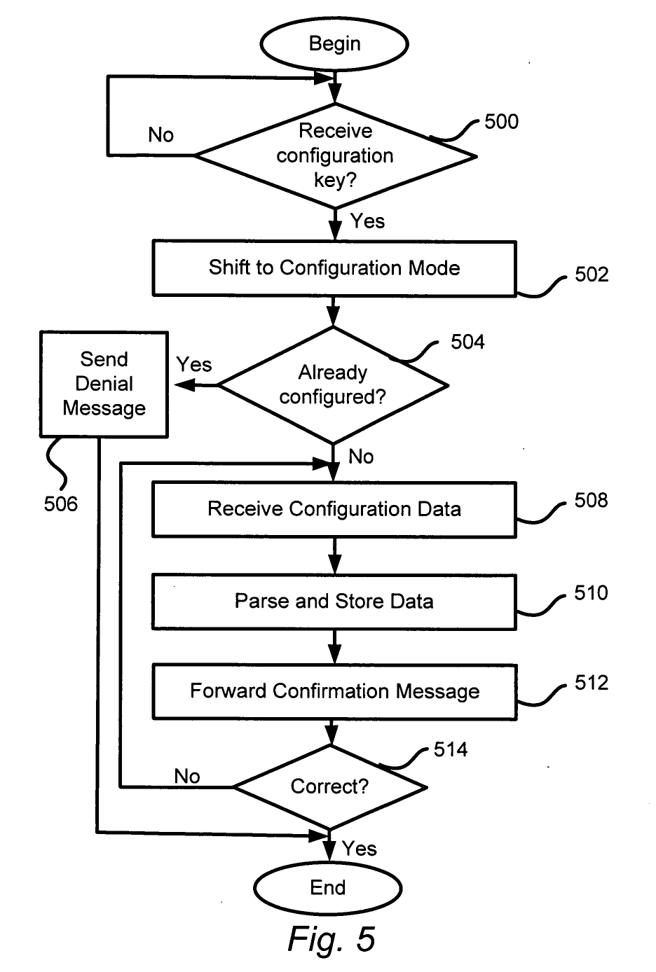

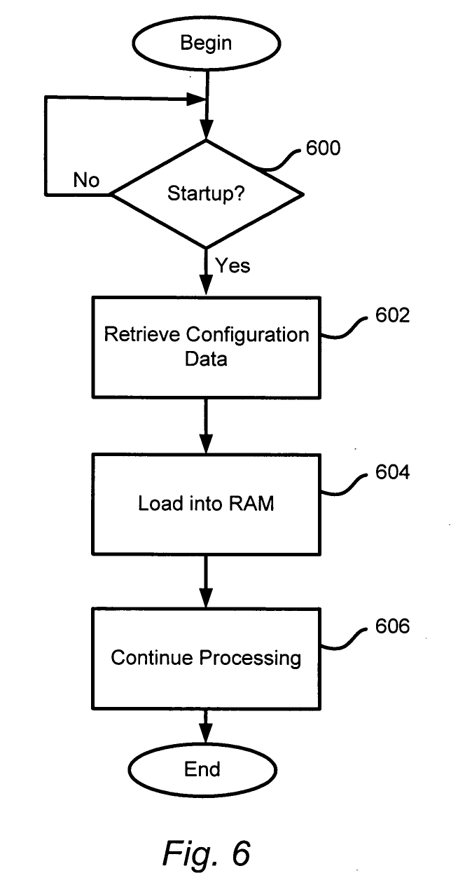

The circuitry portion 24 has circuitry for 1) detecting and processing movement of the movable structure 28, and 2) interacting with external devices, such as the central computer 14 of FIG. 1. To those ends, among other things, the circuitry portion 24 has a communication module 32 for communicating with external devices through a local interface, and a configuration module 34 for configuring the communication module 32. As discussed below, the communication module 32 enables the end-user to configure the communication protocol used by the communication module 32. The configuration module 34 stores the generated configuration data in local memory 36. Details of the interaction between the circuitry portion 24 and sensor portion 22 are discussed in greater detail below with regard to FIGS. 5 and 6.

It should be noted that in illustrative embodiments, both the circuitry portion 24 and sensor portion 22 have a number of additional elements not shown in FIG. 3. Details of some of those additional elements are discussed in greater detail in the above incorporated United States patents.

In some embodiments, the satellite sensor 12 may be formed from two separate die, such as a sensor die having no circuitry, and a circuitry die having the above noted circuitry. Both die illustratively communicate by means of a printed circuit board, wirebonds, or other medium. Accordingly, discussion of a single die is illustrative and not intended to limit all embodiments of the invention.

FIG. 4 schematically shows a block diagram of the configuration module 34 shown in FIG. 3. In general, the modules shown implement selected functions of the well known seven layer ISO (International Organization for Standardization) protocol stack model. Specifically, as known by those skilled in the art, the noted stack model is an ISO standard for worldwide communications that defines a networking framework for implementing protocols in seven layers. When executing according to the standard, one or more devices pass control from one layer to the next, starting at the application layer in one station. Control proceeds over the channel to the bottom layer, and then back up the hierarchy. Accordingly, among other things, the configuration module 34 includes a link layer module 38 for configuring link layer processes, an application layer module 40 for configuring application layer processes, and a physical layer module 42 for configuring physical layer processes.

FIG. 5 shows a process of configuring the satellite sensor 12 in accordance with illustrative embodiments of the invention. The process begins at step 500, which determines if the sensor 12 has received a configuration key from some external configuring device. More particularly, in illustrative embodiments, the sensor 12 has a pin that can be used for configuring the communication module 32, or transmitting/receiving other data. Accordingly, receipt of the configuration key causes the satellite sensor 12 to enter the “configuration mode” (step 502), consequently indicating that configuration data will be received by that pin. Accordingly, until the configuration mode concludes, the sensor 12 uses all data from that pin to configure the communication module 32. In illustrative embodiments, the configuration key is a 16-bit word.

Before beginning configuration processes, however, the sensor 12 determines if the communication module 32 already is configured (step 504). To the end, the process may check specified addresses within memory 36 to determine if the sensor 12 is configured. Among other ways, the process may check a single bit that is set to logical “1” after the sensor 12 is configured. If already configured, then the sensor 12 may transmit a denial message to the external configuring device attempting to configure it (step 506). In addition to indicating that the sensor 12 already has been configured, the denial message also may indicate whether the sensor 12 may be reconfigured, thus prompting the external configuring device to transmit configuration data with this understanding. In illustrative embodiments, however, receipt of the denial message ends the process.

If the sensor 12 has not already been configured, however, then the process continues to step 508, in which the sensor 12 receives configuration data from the external configuring device. Such configuration data may comprise one or more of link layer, application layer, and physical layer data. The appropriate module within the configuration module 34 processes its respectively received configuration data. Among other things, the configuration data may include any of the following:

Physical Layer (ISO layer 1)
Manchester data encoding information, including phase data, and
synchronization pulse enable/disable.

Data Link Layer (ISO layer 2)
data width (e.g., 8 or 10 bit data),
descriptor field: enable/disable, and
error detection: parity or CRC.

Application Layer (ISO layer 7)
serial number and configuration data transmission mode, and
self tests: (e.g., internal self tests pass/fail discrimination or external self test data evaluation).

The process thus continues to step 510, in which the appropriate module(s) parse and store the received configuration data. More particularly, illustrative embodiments receive the configuration data in any one of the number of different types of data frames. For example, the frames may have, among other things, data bits with the configuration data, address bits identifying the address in memory 36 for storing the configuration data, read/write command bits indicating whether operation is a read or write operation, and a parity bit for error checking.

The configuration module 34 illustratively stores the configuration data in one time programmable read-only memory (ROM). Other embodiments, however, may use other types of volatile or nonvolatile memory. By way of example, in illustrative embodiments, the one time programmable read-only memory may be comprised by three 8-bit registers respectively identified as REG0, REG1, and REG2. Table 1 below shows exemplary data that may be stored within specific bits of those registers:

TABLE 1

| Register | Bit 7 | | | | | | | |
|---|---|---|---|---|---|---|---|---|
| Name | (MSB) | Bit 6 | Bit 5 | Bit 4 | Bit 3 | Bit 2 | Bit 1 | Bit 0 (LSB) |
| REG0 | UD | UD | MD1 | MD0 | FDLY | DLY2 | DLY1 | DLY0 |
| REG1 | STI | AZE | SYEN | ADME | ERC | SVD | DAT | MAN |
| REG2 | CUPRG | CUPAR | SCOE | FC1 | FC0 | RG2 | RG1 | RGO |

The codes within Table 1 identified as shown in Table 2 below:

TABLE 2

| CODE | DEFINITION |
|---|---|
| UD | User Data |
| MD1 | Phase 2 mode select 1 |
| MD0 | Phase 2 Mode Select 0 |
| FDLY | Data transmission delay |
| DLY2 | Data transmission delay |
| | select bit 2 |
| DLY1 | Data transmission delay |
| | select bit 1 |
| DLY0 | Data transmission delay |
| | select bit 0 |
| STI | External self test |
| AZE | Auto zero enable |
| SYEN | Sync pulse enable |
| ADME | Auto delay mode |
| | disabled |
| ERC | Parity/CRC select |
| SVD | State vector transmission |
| | enabled |
| DAT | 8/10-bit data |
| MAN | Manchester data |
| | encoding select |
| CUPRG | Configuration register |
| | program bit |
| CUPAR | Configuration register |
| | parity bit |
| SCOE | Signal chain output |
| | enable |
| FC1 | Bessel filter bandwidth |
| | select 1 |
| FC0 | Bessel filter bandwidth |
| | select 0 |
| RG2 | Sensor range select 2 |
| RG1 | Sensor range select 1 |
| RG0 | Sensor range select 0 |

The process then continues to step 512, which forwards a confirmation message to the external configuring device. Specifically, the configuration module 34 transmits a message indicating that configuration has been completed. In some embodiments, however, a confirmation message also may include data indicating whether the configuration process has successfully completed. For example, if the configuration module 34 detects a parity error, it may transmit a confirmation message having data indicating the error. The external configuring device responsively may reinitiate the entire configuration process.

Some embodiments forward configuration data back to the external configuring device as a data integrity check. For example, the configuration module 34 may load the configuration data into random access memory (RAM) from the read-only memory. Next, the configuration module 34 may read the configuration data from the random access memory for transmission to the external configuring device via the confirmation message.

Upon receipt of the confirmation message, the external configuring device may check the received configuration data to confirm its accuracy (step 514). If not accurate, the process loop back to step 508, in which the configuration module 34 again receives the configuration data. Conversely, the process ends if the data is determined to be accurate at step 514.

In contrast to the communication between the communication module 32 and other external devices, the configuration module 34 communicates with the external configuring device (i.e., the device transmitting the configuration data) by means of a fixed communication protocol. In fact, the configuration module 34 may use the communication module 32 to communicate with the external configuring device. Alternatively, the configuration module 34 could use a separate communication means, such as one of many well known serial or parallel communication standards. Some embodiments, however, permit this fixed protocol to also be changed in a manner similar to that discussed above.

In anticipated implementations, the end-user may be provided with a set of options for configuring the communication protocol. Such options may be provided in any number of formats, including an interactive configuration program and/or a specification sheet. As one example, the end-user may be provided with a menu of several different word length formats that the sensor 12 can use. As a second example, the end-user may be provided with several different sets of proprietary configuration protocol data used by various sensor vendors. For example, one set may include the communication protocol data for a sensor distributed by Analog Devices, Inc., while another set may include the communication protocol data for a sensor distributed by another sensor distributor.

After the configuration module 34 configures the communication protocol of the communication module 32 (e.g., by the process of FIG. 5), the sensor 12 can complete other initial processes and/or operate in its intended environment. FIG. 6 shows illustrative initialization process that the sensor 12 may use to retrieve the stored configuration data. The process begins in step 600, which determines that the sensor 12 is in a startup mode. The sensor 12 then retrieves the configuration data from the one time programmable read-only memory (step 602) for storage in random access memory (step 604). Alternatively, the configuration data could remain in the one time programmable read-only memory. At this point, the sensor 12 may continue processing, which involves communicating with external devices (step 606).

Accordingly, illustrative embodiments have the versatility to enable an end-user to configure the sensor 12 to communicate with external devices with any one of a variety of different communication protocols. Such end-users therefore are not limited to sensors that communicate using one communication protocol only. Consequently, rather than focusing on the communication protocol, sensor purchasing decisions may be made based upon a wider variety of other criteria.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., WIFI, microwave, infrared or other transmission techniques). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A MEMS device comprising:
a communication module for communicating with an external device; and
a configuration module operatively coupled with the communication module, the configuration module configuring the communication protocol of the communication module, the communication module communicating with the external device as specified by the communication protocol.

2. The MEMS device as defined by claim 1 further comprising an input for receiving configuration data, the configuration module configuring the communication module in accordance with the configuration data.

3. The MEMS device as defined by claim 1 further comprising memory operatively coupled with the configuration module, the configuration module having logic for storing configuration data in the memory.

4. The MEMS device as defined by claim 3 where the memory includes one-time programmable read-only memory.

5. The MEMS device as defined by claim 1 wherein the configuration module includes control logic for controlling at least one of data width and error detection.

6. The MEMS device as defined by claim 1 wherein the configuration module includes a link layer module configured to control link layer communication of the communication module.

7. The MEMS device as defined by claim 1 wherein the configuration module includes an application layer module configured to control application layer functions of the MEMS device.

8. The MEMS device as defined by claim 1 wherein the configuration module includes a physical layer module configured to control physical layer communication of the communication module.

9. The MEMS device as defined by claim 1 further including a movable mass for detecting an environmental quality, the communication module communicating data relating to the detected environmental quality to the external device.

10. A method of configuring a sensor system, the method comprising:
providing a MEMS device having a communication module for communicating with an external device, and a configuration module operatively coupled with the communication module;
determining at least one communication protocol parameter for controlling communication of the communication module with the external device; and
forwarding the at least one communication protocol parameter to the configuration module, the configuration module storing the at least one communication protocol parameter in memory for retrieval by the communication module.

11. The method as defined by claim 10 wherein the at least one communication protocol parameter includes link layer control data.

12. The method as defined by claim 10 wherein the memory includes one time programmable read-only memory.

13. The method as defined by claim 10 further comprising forwarding a confirmation message having data identifying the at least one communication protocol parameter and a location in memory storing the at least one communication protocol parameter.

14. The method as defined by claim 10 wherein the MEMS device has a sensor for sensing environmental quality, the communication module being incapable of communicating data relating to the sensed environmental quality to the external device until after the at least one communication protocol parameter is stored in the memory.

15. The method as defined by claim 10 further comprising:
detecting that the MEMS device executed a startup process; and
writing the at least one communication protocol parameter from the memory into a volatile memory after startup is detected.

16. A MEMS device comprising:
a communication module for communicating with an external device; and
means for configuring the communication protocol of the communication module with the external device, the configuring means being operatively coupled with the communication module.

17. The MEMS device as defined by claim 16 further comprising means for receiving configuration data, the configuring means configuring the communication protocol of the communication module in accordance with the configuration data.

18. The MEMS device as defined by claim 16 further comprising memory operatively coupled with the configuration module, the configuration module having logic for storing communication protocol configuration data in the memory.

19. The MEMS device as defined by claim 16 wherein the configuring means includes a link layer module configured to control link layer communication of the communication module.

20. The MEMS device as defined by claim 16 wherein the configuring means includes a physical layer module configured to control physical layer communication of the communication module.
